(19) United States
(12) Patent Application Publication
(10) Pub. No.: US 2007/0019661 A1
(43) Pub. Date: Jan. 25, 2007

(54) Packet output buffer for semantic processor

(75) Inventors: Kevin Jerome Rowett, Cupertino, CA (US); Rajesh Nair, Fremont, CA (US); Caveh Jalali, Redwood City, CA (US); Joel Leon Lach, Fremont, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/186,144

(22) Filed: Jul. 20, 2005

(51) Int. Cl. H04L 12/56

(52) U.S. Cl. 370/419

(57) ABSTRACT

An embodiment of the invention is a processor comprising a direct execution parser configured to control the processing of digital data by semantically parsing data; a plurality of semantic processing units configured to perform data operations when prompted by the direct execution parser; and a plurality of output buffers for buffering data received from the plurality of semantic processing units. Another embodiment of the invention is an interface circuit comprising a packer circuit for receiving data from a semantic processing unit and a plurality of buffers for receiving the data. The interface circuit unloads the data received to an interface.

### REFERENCE TO RELATED APPLICATIONS

Copending U.S. patent application Ser. No. 10/351,030, titled “Reconfigurable Semantic Processor,” filed by Somsubhra Sikdar on Jan. 24, 2003, is also incorporated herein by reference.

### BACKGROUND OF THE INVENTION

1. Field of the Invention

This invention relates generally to digital processors and, more specifically, to digital semantic processors for data processing with a direct execution parser.

2. Description of the Related Art

In the data communications field, a packet is a finite-length (generally several tens to several thousands of octets) digital transmission unit comprising one or more header fields and a data field. The data field may contain virtually any type of digital data. The header fields convey information (in different formats depending on the type of header and options) related to delivery and interpretation of the packet contents. This information may, e.g., identify the packet's source or destination, identify the protocol to be used to interpret the packet, identify the packet's place in a sequence of packets, provide an error correction checksum, or aid packet flow control. The finite length of a packet can vary based on the type of network that the packet is to be transmitted through and the type of application used to present the data.

Typically, packet headers and their functions are arranged in an orderly fashion according to the open-systems interconnection (OSI) reference model. This model partitions packet communications functions into layers, each layer performing specific functions in a manner that can be largely independent of the functions of the other layers. As such, each layer can prepend its own header to a packet, and regard all higher-layer headers as merely part of the data to be transmitted. Layer 1, the physical layer, is concerned with transmission of a bit stream over a physical link. Layer 2, the data link layer, provides mechanisms for the transfer of frames of data across a single physical link, typically using a link-layer header on each frame. Layer 3, the network layer, provides network-wide packet delivery and switching functionality—the well-known Internet Protocol (IP) is a layer 3 protocol. Layer 4, the transport layer, can provide mechanisms for end-to-end delivery of packets, such as end-to-end packet sequencing, flow control, and error recovery-Transmission Control Protocol (TCP), a reliable layer 4 protocol that ensures in-order delivery of an octet stream, and User Datagram Protocol, a simpler layer 4 protocol with no guaranteed delivery, are well-known examples of layer 4 implementations. Layer 5 (the session layer), Layer 6 (the presentation layer), and Layer 7 (the application layer) perform higher-level functions such as communication session management, data formatting, data encryption, and data compression.

Not all packets follow the basic pattern of cascaded headers with a simple payload. For instance, packets can undergo IP fragmentation when transferred through a network and can arrive at a receiver out-of-order. Some protocols, such as the Internet Small Computer Systems Interface (iSCSI) protocol, allow aggregation of multiple headers/data payloads in a single packet and across multiple packets. Since packets are used to transmit secure data over a network, many packets are encrypted before they are sent, which causes some headers to be encrypted as well.

Since these multi-layer packets have a large number of variations, typically, programmable computers are needed to ensure packet processing is performed accurately and effectively. Traditional programmable computers use a von Neumann, or VN, architecture. The VN architecture, in its simplest form, comprises a central processing unit (CPU) and attached memory, usually with some form of input/output to allow useful operations. The VN architecture is attractive, as compared to gate logic, because it can be made “general-purpose” and can be reconfigured relatively quickly; by merely loading a new set of program instructions, the function of a VN machine can be altered to perform even very complex functions, given enough time. The tradeoffs for the flexibility of the VN architecture are complexity and inefficiency. Thus, the ability to do almost anything comes at the cost of being able to do a few simple things efficiently.

### DESCRIPTION OF THE DRAWINGS

The invention may be best understood by reading the disclosure with reference to the drawings.

FIG. 1 illustrates, in block form, a semantic processor useful with embodiments of the invention.

FIG. 2 contains a flow chart for the processing of received packets in the semantic processor with the recirculation buffer in FIG. 1.

FIG. 3 illustrates a more detailed semantic processor implementation useful with embodiments of the invention.

FIG. 4 contains a flow chart of received IP-fragmented packets in the semantic processor in FIG. 3.

FIG. 5 contains a flow chart of received encrypted and/or unauthenticated packets in the semantic processor in FIG. 3.

FIG. 6 illustrates yet another semantic processor implementation useful with embodiments of the invention.

FIG. 7 illustrates an embodiment of the packet output buffer in the semantic processor in FIG. 6.

FIG. 8 illustrates the information contained in the buffer in FIG. 7.

### DETAILED DESCRIPTION OF THE EMBODIMENTS

The invention relates to digital semantic processors for data processing with a direct execution parser. Many digital devices either in service or on the near horizon fall into the general category of packet processors. In many such devices, what is done with the data received is straightforward, but the packet protocol and packet processing are too complex to warrant the design of special-purpose hardware. Instead, such devices use a VN machine to implement the protocols.

It is recognized herein that a different and attractive approach exists for packet processors, an approach that can be described more generally as a semantic processor. Such a device is preferably reconfigurable like a VN machine, as its processing depends on its “programming”—although, as will be seen, this “programming” is unlike conventional machine code used by a VN machine. Whereas a VN machine always executes a set of machine instructions that check for various data conditions sequentially, the semantic processor responds directly to the semantics of an input stream. Semantic processors, thus, have the ability to process packets more quickly and efficiently than their VN counterparts. The invention is now described in more detail.

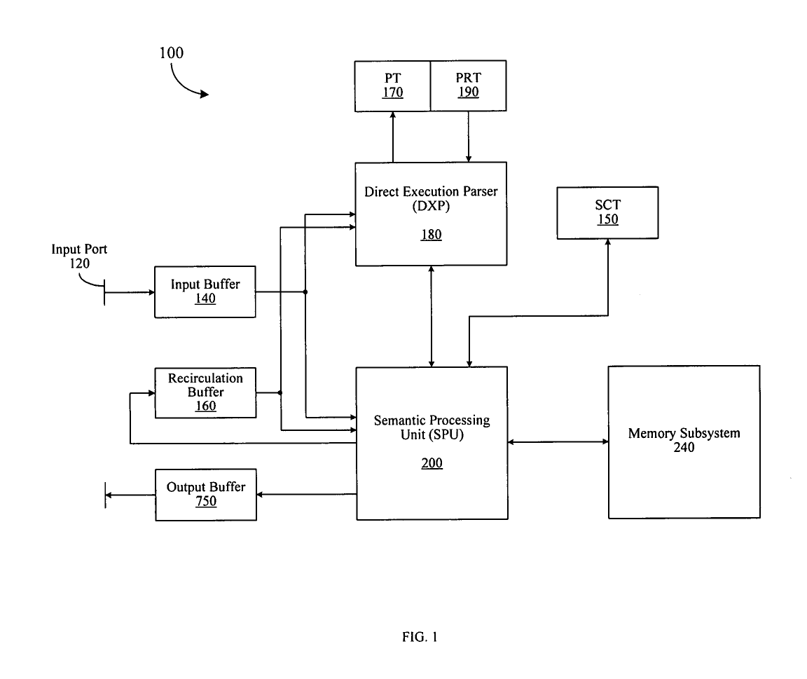

FIG. 1 shows a block diagram of a semantic processor 100 according to an embodiment of the invention. The semantic processor 100 contains an input buffer 140 for buffering a packet data stream (e.g., the input stream) received through the input port 120, a direct execution parser (DXP) 180 that controls the processing of packet data received at the input buffer 140, a recirculation buffer 160, a semantic processing unit (SPU) 200 for processing segments of the packets or for performing other operations, a memory subsystem 240 for storing and/or augmenting segments of the packets, and an output buffer 750 for buffering a data stream (e.g., the output stream) received from the SPU 200.

The DXP 180 maintains an internal parser stack (not shown) of terminal and non-terminal symbols, based on parsing of the current frame up to the current symbol. For instance, each symbol on the internal parser stack is capable of indicating to the DXP 180 a parsing state for the current input frame or packet. When the symbol (or symbols) at the top of the parser stack is a terminal symbol, DXP 180 compares data at the head of the input stream to the terminal symbol and expects a match in order to continue. When the symbol at the top of the parser stack is a non-terminal symbol, DXP 180 uses the non-terminal symbol and current input data to expand the grammar production on the stack. As parsing continues, DXP 180 instructs SPU 200 to process segments of the input stream or perform other operations. The DXP 180 may parse the data in the input stream prior to receiving all of the data to be processed by the semantic processor 100. For instance, when the data is packetized, the semantic processor 100 may begin to parse through the headers of the packet before the entire packet is received at input port 120.

Semantic processor 100 uses at least three tables. Code segments for SPU 200 are stored in semantic code table (SCT) 150. Complex grammatical production rules are stored in a production rule table (PRT) 190. Production rule codes for retrieving those production rules are stored in a parser table (PT) 170. The production rule codes in parser table 170 allow DXP 180 to detect whether, for a given production rule, a code segment from SCT 150 should be loaded and executed by SPU 200.

Some embodiments of the invention contain many more elements than those shown in FIG. 1, but these essential elements appear in every system or software embodiment. Thus, a description of the packet flow within the semantic processor 100 shown in FIG. 1 will be given before more complex embodiments are addressed.

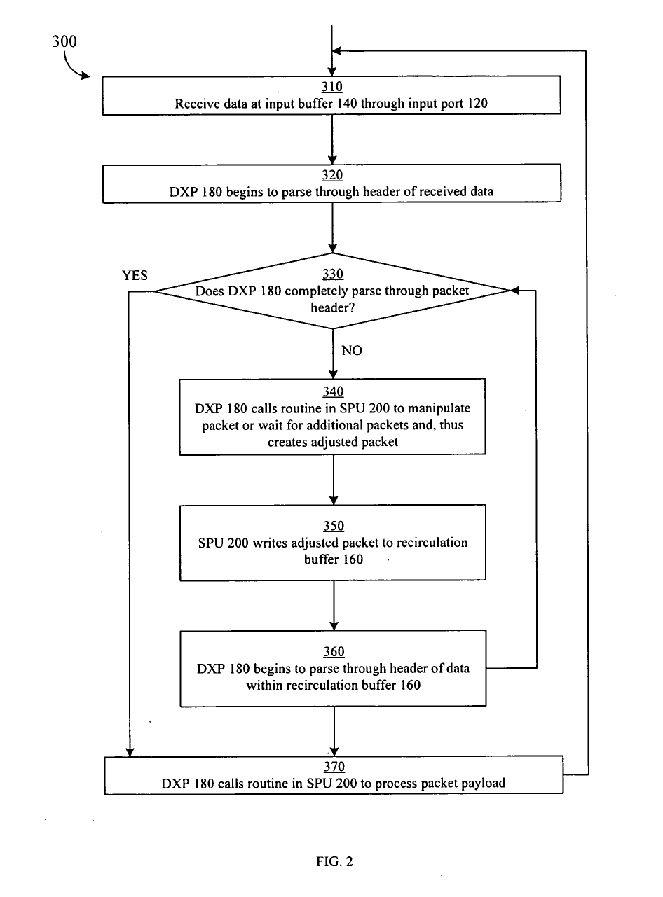

FIG. 2 contains a flow chart 300 for the processing of received packets through the semantic processor 100 of FIG. 1. The flowchart 300 is used for illustrating a method of the invention.

According to a block 310, a packet is received at the input buffer 140 through the input port 120. According to a next block 320, the DXP 180 begins to parse through the header of the packet within the input buffer 140. According to a decision block 330, it is determined whether the DXP 180 was able to completely parse through header. In the case where the packet needs no additional manipulation or additional packets to enable the processing of the packet payload, the DXP 180 will completely parse through the header. In the case where the packet needs additional manipulation or additional packets to enable the processing of the packet payload, the DXP 180 will cease to parse the header.

If the DXP 180 was able to completely parse through the header, then according to a next block 370, the DXP 180 calls a routine within the SPU 200 to process the packet payload. The semantic processor 100 then waits for a next packet to be received at the input buffer 140 through the input port 120.

If the DXP 180 had to cease parsing the header, then according to a next block 340, the DXP 180 calls a routine within the SPU 200 to manipulate the packet or wait for additional packets. Upon completion of the manipulation or the arrival of additional packets, the SPU 200 creates an adjusted packet.

According to a next block 350, the SPU 200 writes the adjusted packet (or a portion thereof) to the recirculation buffer 160. This can be accomplished by either enabling the recirculation buffer 160 with direct memory access to the memory subsystem 240 or by having the SPU 200 read the adjusted packet from the memory subsystem 240 and then write the adjusted packet to the recirculation buffer 160. Optionally, to save processing time within the SPU 200, instead of the entire adjusted packet, a specialized header can be written to the recirculation buffer 160. This specialized header directs the SPU 200 to process the adjusted packet without having to transfer the entire packet out of memory subsystem 240.

According to a next block 360, the DXP 180 begins to parse through the header of the data within the recirculation buffer 160. Execution is then returned to block 330, where it is determined whether the DXP 180 was able to completely parse through the header. If the DXP 180 was able to completely parse through the header, then according to a next block 370, the DXP 180 calls a routine within the SPU 200 to process the packet payload and the semantic processor 100 waits for a next packet to be received at the input buffer 140 through the input port 120.

If the DXP 180 had to cease parsing the header, execution returns to block 340 where the DXP 180 calls a routine within the SPU 200 to manipulate the packet or wait for additional packets, thus creating an adjusted packet. The SPU 200 then writes the adjusted packet to the recirculation buffer 160, and the DXP 180 begins to parse through the header of the packet within the recirculation buffer 160.

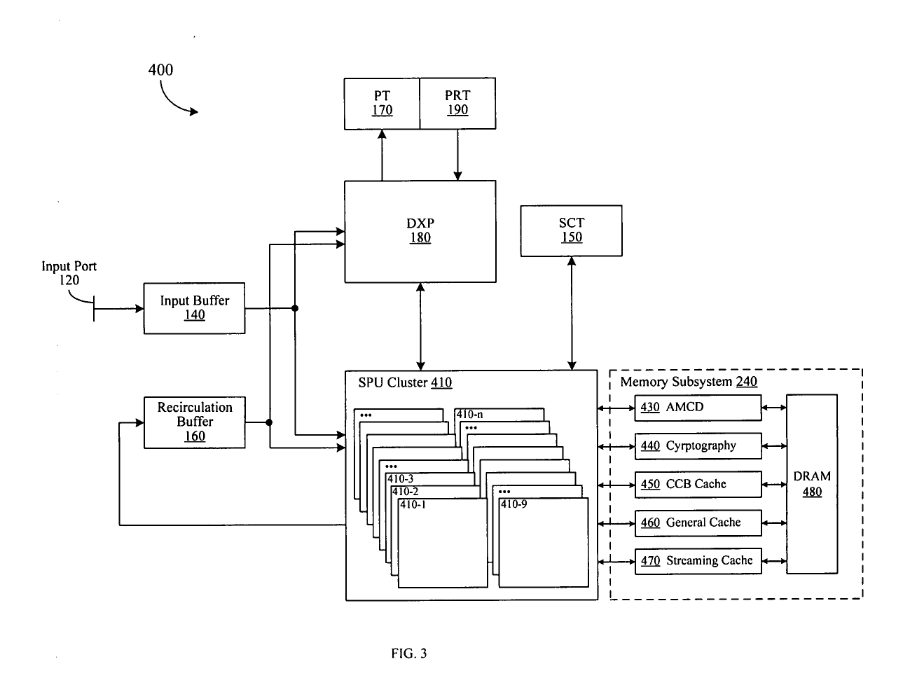

FIG. 3 shows another semantic processor embodiment 400. Semantic processor 400 includes memory subsystem 240, which comprises an array machine-context data memory (AMCD) 430 for accessing data in dynamic random access memory (DRAM) 480 through a hashing function or content-addressable memory (CAM) lookup, a cryptography block 440 for encryption or decryption, and/or authentication of data, a context control block (CCB) cache 450 for caching context control blocks to and from DRAM 480, a general cache 460 for caching data used in basic operations, and a streaming cache 470 for caching data streams as they are being written to and read from DRAM 480. The context control block cache 450 is preferably a software-controlled cache, i.e., the SPU 410 determines when a cache line is used and freed.

The SPU 410 is coupled with AMCD 430, cryptography block 440, CCB cache 450, general cache 460, and streaming cache 470. When signaled by the DXP 180 to process a segment of data in memory subsystem 240 or received at input buffer 120 (FIG. 1), the SPU 410 loads microinstructions from semantic code table (SCT) 150. The loaded microinstructions are then executed in the SPU 410 and the segment of the packet is processed accordingly.

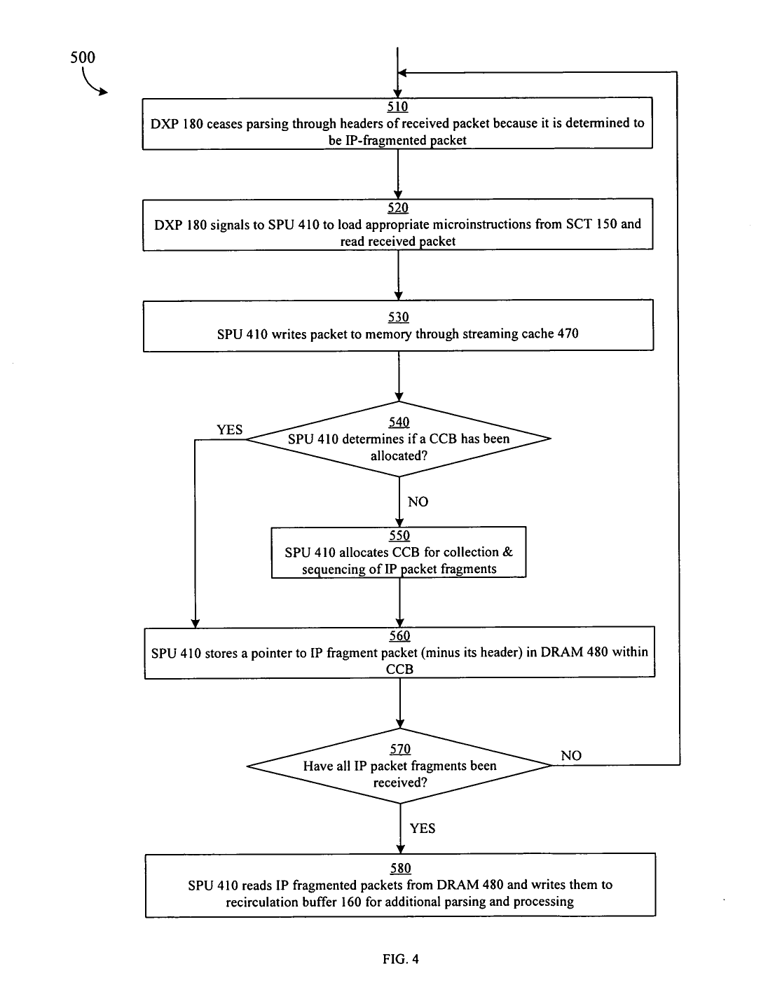

FIG. 4 contains a flow chart 500 for the processing of received Internet Protocol (IP)-fragmented packets through the semantic processor 400 of FIG. 3. The flowchart 500 is used for illustrating one method according to an embodiment of the invention.

Once a packet is received at the input buffer 140 through the input port 120 and the DXP 180 begins to parse through the headers of the packet within the input buffer 140, according to a block 510, the DXP 180 ceases parsing through the headers of the received packet because the packet is determined to be an IP-fragmented packet. Preferably, the DXP 180 completely parses through the IP header, but ceases to parse through any headers belonging to subsequent layers, such as TCP, UDP, iSCSI, etc.

According to a next block 520, the DXP 180 signals to the SPU 410 to load the appropriate microinstructions from the SCT 150 and read the received packet from the input buffer 140. According to a next block 530, the SPU 410 writes the received packet to DRAM 480 through the streaming cache 470. Although blocks 520 and 530 are shown as two separate steps, optionally, they can be performed as one step—with the SPU 410 reading and writing the packet concurrently. This concurrent operation of reading and writing by the SPU 410 is known as SPU pipelining, where the SPU 410 acts as a conduit or pipeline for streaming data to be transferred between two blocks within the semantic processor 400.

According to a next decision block 540, the SPU 410 determines if a Context Control Block (CCB) has been allocated for the collection and sequencing of the correct IP packet fragments. Preferably, the CCB for collecting and sequencing the fragments corresponding to an IP-fragmented packet is stored in DRAM 480. The CCB contains pointers to the IP fragments in DRAM 480, a bit mask for the IP-fragmented packets that have not arrived, and a timer value to force the semantic processor 400 to cease waiting for additional IP-fragmented packets after an allotted period of time and to release the data stored in the CCB within DRAM 480.

The SPU 410 preferably determines if a CCB has been allocated by accessing the AMCD's 430 content-addressable memory (CAM) lookup function using the IP source address of the received IP-fragmented packet combined with the identification and protocol from the header of the received IP packet fragment as a key. Optionally, the IP fragment keys are stored in a separate CCB table within DRAM 480 and are accessed with the CAM by using the IP source address of the received IP-fragmented packet combined with the identification and protocol from the header of the received IP packet fragment. This optional addressing of the IP fragment keys avoids key overlap and sizing problems.

If the SPU 410 determines that a CCB has not been allocated for the collection and sequencing of fragments for a particular IP-fragmented packet, execution then proceeds to a block 550 where the SPU 410 allocates a CCB. The SPU 410 preferably enters a key corresponding to the allocated CCB, the key comprising the IP source address of the received IP fragment and the identification and protocol from the header of the received IP-fragmented packet, into an IP fragment CCB table within the AMCD 430, and starts the timer located in the CCB. When the first fragment for given fragmented packet is received, the IP header is also saved to the CCB for later recirculation. For further fragments, the IP header need not be saved.

Once a CCB has been allocated for the collection and sequencing of IP-fragmented packet, the SPU 410 stores a pointer to the IP-fragmented packet (minus its IP header) in DRAM 480 within the CCB, according to a next block 560. The pointers for the fragments can be arranged in the CCB as, e.g., a linked list. Preferably, the SPU 410 also updates the bit mask in the newly allocated CCB by marking the portion of the mask corresponding to the received fragment as received.

According to a next decision block 570, the SPU 410 determines if all of the IP fragments from the packet have been received. Preferably, this determination is accomplished by using the bit mask in the CCB. A person of ordinary skill in the art can appreciate that there are multiple techniques readily available to implement the bit mask, or an equivalent tracking mechanism, for use with the invention.

If all of the fragments have not been received for the IP-fragmented packet, then the semantic processor 400 defers further processing on that fragmented packet until another fragment is received.

If all of the IP fragments have been received, according to a next block 580, the SPU 410 resets the timer, reads the IP fragments from DRAM 480 in the correct order, and writes them to the recirculation buffer 160 for additional parsing and processing. Preferably, the SPU 410 writes only a specialized header and the first part of the reassembled IP packet (with the fragmentation bit unset) to the recirculation buffer 160. The specialized header enables the DXP 180 to direct the processing of the reassembled IP-fragmented packet stored in DRAM 480 without having to transfer all of the IP-fragmented packets to the recirculation buffer 160. The specialized header can consist of a designated non-terminal symbol that loads parser grammar for IP and a pointer to the CCB. The parser can then parse the IP header normally and proceed to parse higher-layer (e.g., TCP) headers.

In an embodiment of the invention, DXP 180 decides to parse the data received at either the recirculation buffer 160 or the input buffer 140 through round robin arbitration. A high level description of round robin arbitration will now be discussed with reference to a first and a second buffer for receiving packet data streams. After completing the parsing of a packet within the first buffer, DXP 180 looks to the second buffer to determine if data is available to be parsed. If so, the data from the second buffer is parsed. If not, then DXP 180 looks back to the first buffer to determine if data is available to be parsed. DXP 180 continues this round robin arbitration until data is available to be parsed in either the first buffer or second buffer.

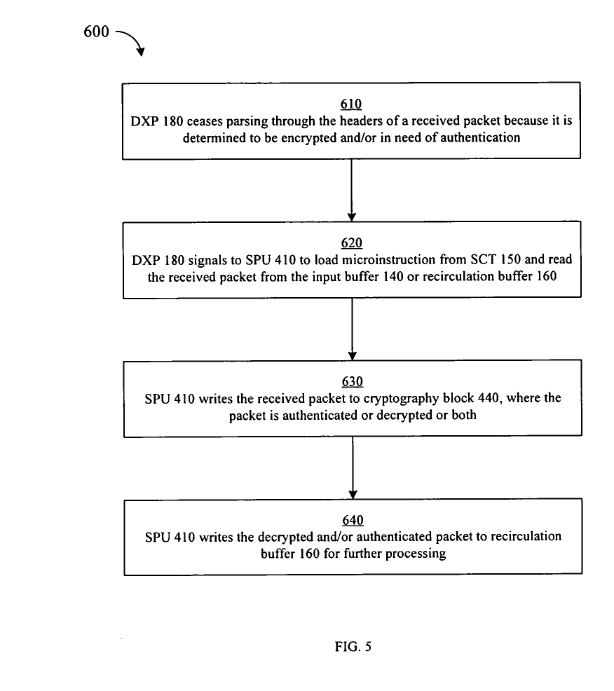

FIG. 5 contains a flow chart 600 for the processing of received packets in need of decryption and/or authentication through the semantic processor 400 of FIG. 3. The flowchart 600 is used for illustrating another method according to an embodiment of the invention.

Once a packet is received at the input buffer 140 or the recirculation buffer 160 and the DXP 180 begins to parse through the headers of the received packet, according to a block 610, the DXP 180 ceases parsing through the headers of the received packet because it is determined that the packet needs decryption and/or authentication. If DXP 180 begins to parse through the packet headers from the recirculation buffer 160, preferably, the recirculation buffer 160 will only contain the aforementioned specialized header and the first part of the reassembled IP packet.

According to a next block 620, the DXP 180 signals to the SPU 410 to load the appropriate microinstructions from the SCT 150 and read the received packet from input buffer 140 or recirculation buffer 160. Preferably, SPU 410 will read the packet fragments from DRAM 480 instead of the recirculation buffer 160 for data that has not already been placed in the recirculation buffer 160.

According to a next block 630, the SPU 410 writes the received packet to cryptography block 440, where the packet is authenticated, decrypted, or both. In a preferred embodiment, decryption and authentication are performed in parallel within cryptography block 440. The cryptography block 440 enables the authentication, encryption, or decryption of a packet through the use of Triple Data Encryption Standard (T-DES), Advanced Encryption Standard (AES), Message Digest 5 (MD-5), Secure Hash Algorithm 1 (SHA-1), Rivest Cipher 4 (RC-4) algorithms, etc. Although block 620 and 630 are shown as two separate steps, optionally, they can be performed as one step with the SPU 410 reading and writing the packet concurrently.

The decrypted and/or authenticated packet is then written to SPU 410 and, according to a next block 640, the SPU 410 writes the packet to the recirculation buffer 160 for further processing. In a preferred embodiment, the cryptography block 440 contains a direct memory access engine that can read data from and write data to DRAM 480. By writing the decrypted and/or authenticated packet back to DRAM 480, SPU 410 can then readjust the headers of the decrypted and/or authenticated packet from DRAM 480 and subsequently write them to the recirculation buffer 160. Since the payload of the packet remains in DRAM 480, semantic processor 400 saves processing time. Like with IP fragmentation, a specialized header can be written to the recirculation buffer to orient the parser and pass CCB information back to SPU 410.

Multiple passes through the recirculation buffer 160 may be necessary when IP fragmentation and encryption/authentication are contained in a single packet received by the semantic processor 400.

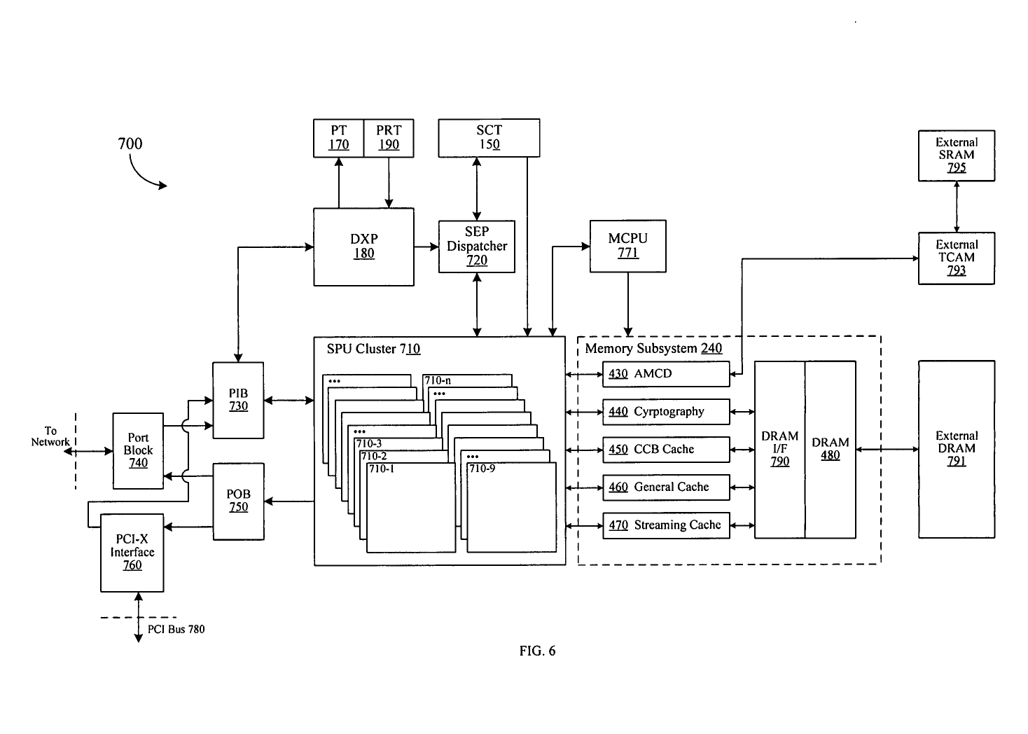

FIG. 6 shows yet another semantic processor embodiment. Semantic processor 700 contains a semantic processing unit (SPU) cluster 410 containing a plurality of semantic processing units 410-1, 410-2, 410-n. Preferably, each of the SPUs 410-1 to 410-n is identical and has the same functionality. The SPU cluster 410 is coupled to the memory subsystem 240, a SPU entry point (SEP) dispatcher 720, the SCT 150, port input buffer (PIB) 730, packet output buffer (POB) 750, and a machine central processing unit (MCPU) 771.

When DXP 180 determines that a SPU task is to be launched at a specific point in parsing, DXP 180 signals SEP dispatcher 720 to load microinstructions from SCT 150 and allocate a SPU from the plurality of SPUs 410-1 to 410-n within the SPU cluster 410 to perform the task. The loaded microinstructions and task to be performed are then sent to the allocated SPU. The allocated SPU then executes the microinstructions and the data packet is processed accordingly. The SPU can optionally load microinstructions from the SCT 150 directly when instructed by the SEP dispatcher 720.

The MCPU 771 is coupled with the SPU cluster 410 and memory subsystem 240. The MCPU 771 may perform any desired function for semantic processor 700 that can be reasonably accomplished with traditional software running on standard hardware. These functions are usually infrequent, non-time-critical functions that do not warrant inclusion in SCT 150 due to complexity. Preferably, the MCPU 771 also has the capability to communicate with the dispatcher in SPU cluster 410 in order to request that a SPU perform tasks on the MCPU's behalf.

In an embodiment of the invention, the memory subsystem 240 further comprises a DRAM interface 790 that couples the cryptography block 440, context control block cache 450, general cache 460, and streaming cache 470 to DRAM 480 and external DRAM 791. In this embodiment, the AMCD 430 connects directly to an external TCAM 793, which, in turn, is coupled to an external Static Random Access Memory (SRAM) 795.

The PIB 730 contains at least one network interface input buffer, a recirculation buffer, and a Peripheral Component Interconnect (PCI-X) input buffer. The POB 750 contains at least one network interface output buffer and a Peripheral Component Interconnect (PCI-X) output buffer. The port block 740 contains one or more ports, each comprising a physical interface, e.g., an optical, electrical, or radio frequency driver/receiver pair for an Ethernet, Fibre Channel, 802.11x, Universal Serial Bus, Firewire, or other physical layer interface. Preferably, the number of ports within port block 740 corresponds to the number of network interface input buffers within the PIB 730 and the number of output buffers within the POB 750.

The PCI-X interface 760 is coupled to a PCI-X input buffer within the PIB 730, a PCI-X output buffer within the POB 750, and an external PCI bus 780. The PCI bus 780 can connect to other PCI-capable components, such as disk drive, interfaces for additional network ports, etc.

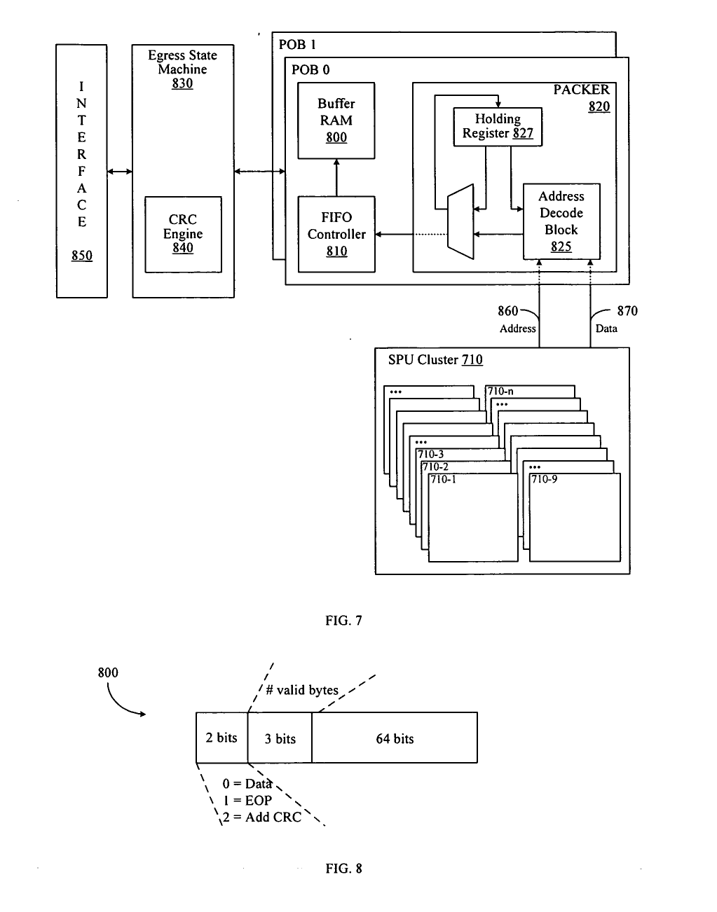

FIG. 7 shows one embodiment of the POB 750 in more detail. The POB 750 comprises two FIFO controllers and two buffers implemented in RAM. For each FIFO controller, the POB 750 includes a packer which comprises an address decoder. The output of the POB 750 is coupled to an egress state machine which then connects to an interface.

As shown in FIG. 8, each buffer is 69 bits wide. The lower 64 bits of the buffer hold data, followed by three bits of encoded information to indicate how many bytes in that location are valid. Then two bits on the end are used to provide additional information, such as: a 0 indicates data; a 1 indicates end of packet (EOP); a 2 indicates Cyclic Redundance Code (CRC); and 3 is reserved.

The buffer holds 8 bytes of data. However, the packets of data sent to the buffer may be formed in “scatter-gather” format. That is, the header of the packer can be in one location in memory while the rest of the packet can be in another location. Thus, when the SPU writes to the POB 750, the SPU may, for example, first write 3 bytes of data and then write another 3 bytes of data. To avoid having to write partial bytes into the RAM, the POB 750 includes a packer for holding bytes of data in a holding register until enough bytes are accumulated to send to the buffer.

Referring back to FIG. 7, the SPUs in the SPU cluster 710 access the POB 750 via the address bus and the data bus. To determine how many of the bytes of data sent from the SPU are valid, the packer in the POB 750 decodes the lower 3 bits of the address, i.e. bits [2:0] of the address. In one embodiment, the address decoding scheme implemented may be as shown in Table 1 below.

TABLE 1

| Address [2:0] | Number of bytes |
|---|---|
| 0 | Write 8 |
| 1 | Write 1 |
| 2 | Write 2 |
| 3 | Write 3 |
| 4 | Write 4 |
| 5 | Write 5 |
| 6 | Write 6 |
| 7 | Write 7 |

When the packer has decoded the address, the packer then determines whether it has enough data to commit to the RAM. If the packer determines there are not enough data, the packer sends the data into the holding register. When enough bytes have been accumulated in the holding register, the data is pushed into the FIFO controller and sent to the RAM. In some cases, the SPU in the SPU cluster 710 may write an EOP into the packer. Here, the packer sends all of the data to the RAM. In one embodiment, the packer may be implemented using flip-flop registers.

The POB 750 further comprises an egress state machine. The egress state machine tracks the states of each FIFO; the state machine senses that a FIFO has data and unloads the FIFO to the interface. The state machine then alternates to the other FIFO and unloads that FIFO to the interface. If both FIFOs are empty, the state machine will assume that the first FIFO has data and then alternate between the FIFOs, unloading them to the interface. Thus, data in the packer is sent out in the order it was written into the packer.

The POB 750 includes a CRC engine to detect error conditions in the buffered data. Error conditions which may be encountered include underruns and invalid EOP. In an overrun condition, the SPU cannot feed data quickly enough into the POB 750 and there are not enough packets to process. With an invalid EOP error, an EOP is written into the packer while there is no packet in flight. These two conditions will flag an error which shut off the POB 750, thereby preventing the SPUs from accessing the buffers.

In one embodiment, underruns may be avoided by setting a programmable threshold to indicate when to start sending out the packets to the buffer. For example, underruns can be avoided altogether if the threshold is set to be the end of packet. In this case, packets will not be sent until the end of packet is sent and underruns will not occur. However, performance will not be optimal at this threshold.

Each SPU in the SPU cluster can access the POB 750. However, to prevent corruption of packets sent to the POB 750, only one SPU can write into the FIFO. In one embodiment, a token mechanism, such as flags maintained in external memory, may be used to indicate which SPU can access the POB 750. Another SPU cannot access the buffer until released by the first SPU.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

What is claimed is:

1. An interface circuit, comprising:
a packer circuit for receiving data from a semantic processing unit; and
a plurality of buffers for buffering the data received from the semantic processing unit.

2. The interface circuit of claim 1, wherein the packer circuit comprises:
an address decoder for determining a number of valid bytes in the data received from the semantic processing unit.

3. The interface circuit of claim 2, wherein the address decoder determines the number of valid bytes in the data according to a value encoded in the address of the data received.

4. The interface circuit of claim 2, wherein the packer circuit further comprises:
a holding register for storing the data if the number of bytes in the data received from the semantic processing unit is less than a predetermined number.

5. The interface circuit of claim 1, further comprising:
a controller for controlling access to the plurality of buffers by the semantic processing unit.

6. The interface circuit of claim 1, further comprising:
an egress state machine for unloading the data in the plurality of buffers to an interface.

7. The interface circuit of claim 6, wherein the interface is a network interface port.

8. The interface circuit of claim 6, wherein the interface is a peripheral component interface.

9. The interface circuit of claim 6, wherein the egress state machine unloads the data in the plurality of buffers to the interface in a round-robin manner.

10. The interface circuit of claim 1, further comprising an error detection circuit configured to notify the semantic processing unit of errors in the buffered data.

11. The interface circuit of claim 1, wherein the error detection circuit computes Cyclic Redundancy Codes using the buffered data.

12. The interface circuit of claim 11, wherein the error detection circuit sends error information to the semantic processing unit.

13. The interface circuit of claim 11, wherein the error detection circuit prevents access by the semantic processing unit when errors are detected.

14. A processor, comprising:
a direct execution parser configured to control the processing of digital data by semantically parsing data;
a plurality of semantic processing units configured to perform data operations when prompted by the direct execution parser; and
a plurality of output buffers for buffering data received from the plurality of semantic processing units.

15. The processor of claim 14, wherein each of the plurality of output buffers is configured for access by only one of the plurality of semantic processing units at any given time.

16. The processor of claim 14, further comprising a token mechanism for indicating which semantic processing unit can access the plurality of output buffers.

17. The processor of claim 14, wherein the plurality of output buffers send data received from the plurality of semantic processing units to a network interface port.

18. The processor of claim 14, wherein the plurality of output buffers send data received from the plurality of semantic processing unit to a peripheral component.
